(19) United States
(12) Patent Application Publication
(10) Pub. No.: US 2011/0029461 A1
(43) Pub. Date: Feb. 3, 2011

(54) Dynamic Electrical Power Pricing Communication Architecture

(75) Inventor: David B. Hardin, JR., Franklin, MA (US)

Correspondence Address: CONLEY ROSE, P.C., 5601 GRANITE PARKWAY, SUITE 750, PLANO, TX, 75024, US

(73) Assignee: INVENSYS SYSTEMS INC., Foxboro, MA (US)

(21) Appl. No.: 12/847,834

(22) Filed: Jul. 30, 2010

Related U.S. Application Data
(60) Provisional application No. 61/230,106, filed on Jul. 31, 2009.

(51) Int. Cl. G06Q 50/00; G06F 17/00

(52) U.S. Cl. 705/412

(57) ABSTRACT

A dynamic electrical power pricing communication system is provided. The system comprises at least one computer system, at least one memory, a data analysis application that receives status information from residential consumers and analyzes the status information. The system further comprises an electrical power price generation application that determines dynamic electrical power prices for the residential consumers based on the analysis of the status information, on an area of the residential consumers, wherein the electrical power prices of each area are determined independently. The system further comprises a power price distribution application that transmits the power prices to the residential consumers. The status information comprises one or more of when the last electrical price was received, what the last received electrical power price value was, how much load can be shed by the residential consumer, a control mode of an electrical power controller, and communication network diagnostic information.

### CROSS-REFERENCE TO RELATED APPLICATIONS

The present application claims priority to U.S. provisional patent application No. 61/230,106 filed Jul. 31, 2009, by David B. Hardin, Jr. entitled “Dynamic Electrical Power Pricing Communication Architecture, which is incorporated by reference herein as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Abundant, reliable electrical power is closely correlated with high standards of living and with advanced economies. The electrical power infrastructure comprises electrical power generation, electrical power transmission, and electrical power distribution equipment. Electrical power may be produced by generators driven by prime movers including steam turbines powered by steam heated by geothermal sources, nuclear cores or by combustion of fossil fuels such as coal, oil, and natural gas. Alternatively, electrical power may be produced by generators driven by water turbines or wind turbines. Often electrical power is generated at locations that are relatively distant from the urban and manufacturing centers where the bulk of electrical power is consumed. Electrical power is typically boosted in voltage and reduced in amperage by transformers for transmission on high tension (i.e., high voltage) lines over long distances to these centers of electrical power consumption. Electrical power is typically reduced in voltage and increased in amperage in a series of voltage step-down transformers proximate to the point of electrical power consumption, for example consumption in a residence, consumption in a business, or consumption in a manufacturing plant. An electrical sub-station, for example, may step down the high voltage of the transmission lines to an intermediate voltage for power distribution to residential neighborhoods and/or to business parks. Additional transformers may step down the intermediate voltage to a relatively low voltage, for example about 120 volts and/or about 220 volts, for power distribution to individual homes and or businesses. The aggregate of transmission lines, sub-station transformers, step down transformers, and other electrical power switching and conditioning equipment may be collectively referred to as the electrical power grid or more concisely the grid.

The grid can receive electrical power generated from a wide number of different and dynamically changing generators and deliver this electrical power to a wide number of different and dynamically changing electrical power consumption loads. For example, at one time electrical power may be sourced from generators A, B, and C and supplied to a city; at a second time electrical power may be sourced from generators A, D, and E and supplied to the city, while generators B and C are off-line or are sourcing electrical power to a different city. Electrical power may be generated by private enterprises, such as an aluminum mill, for use in a private business, and the private business may sell surplus electricity to the electrical utilities that operate the grid. Electrical power may be generated as a means of recovering energy incidental to a primary energy consuming process by a private business, which may be referred to as co-generation, and this co-generated electrical power may be sold to the electrical utilities that operate the grid. Similarly, private individuals may own and operate small electrical power generating facilities, for example small wind mill driven generators and/or solar power panels, and the private individuals may sell surplus electrical power to the electrical utilities. Generalizing, any selling of electrical power to the electric utilities by private individuals and/or businesses not primarily in the business of electrical power distribution may be referred to as exporting electrical power to the grid.

The electrical power loads consumed by residences and businesses change dynamically. In a residence, an electrical power load, i.e., the amount of electrical power consumed, may increase as an air conditioner switches on, an electric clothes dryer operates, and as a television is turned on. The electrical power load of a residence may exhibit a pattern of diurnal variations. For example, a typical residence may place a peak load on the grid at about 5 PM in the summer when air conditioning is struggling to maintain comfortable temperatures in the home and occupants are returning from work and/or school, turning on electrical appliances and entertainment electronic devices. The typical residence may place a minimum load on the grid early in the morning when air conditioning is least active and other appliances and entertainment electronic devices are turned off. Businesses likewise place a dynamically changing load on the grid. A typical business may place a peak load on the grid during business hours during the week and may present a much lower load on the grid when the business is closed, for example after hours and/or on the weekend.

Concern about the aging electrical power grid and about the configuration of the electrical power grid with reference to the location of electrical power generating plant relative to the concentration of electrical power consumers in growing urban areas has been increased recently by high-profile electrical power system failures and brown-outs. New technologies such as electric and hybrid vehicles are expected to place new electrical loads on the grid. Additionally, concerns about energy independence and anthropogenic climate change have increased interest in deploying non-traditional electrical generation plants in new areas, which places different demands on the electrical power grid. In response to these several concerns and issues, the electrical power industry and the government have both awakened to the need to update and refurbish the grid in various ways to assure abundant and reliable electrical power. For example, the United States Department of Energy (DoE) and the United States National Institute of Science and Technology (NIST) are involved in efforts to promote and standardize a Smart Grid that would provide an information environment overlay of the existing electrical power grid that has the objective of delivering electrical power from generators to consumers using information technology to save energy, reduce cost, promote renewable energy generation, and increase reliability.

### SUMMARY

In an embodiment, a dynamic electrical power pricing communication system is disclosed. The system comprises at least one computer system, at least one memory, a data analysis application stored in the at least one memory, a dynamic electrical power price generation application stored in the at least one memory, and a dynamic electrical power price distribution application stored in the at least one memory. When executed by the at least one computer system, the data analysis application receives status information from a plurality of residential consumers and analyzes the status information, wherein the residential consumers are located in a plurality of districts, each district comprising a plurality of areas, each area comprising a plurality of residential consumers, and wherein at least one residential consumer in each area periodically automatically transmits status information to the data analysis application. When executed by the at least one computer system, the dynamic electrical power price generation application receives wholesale electrical power pricing information and determines a plurality of dynamic electrical power prices for the residential consumers based on the analysis of the status information, based on the area of the residential consumers, wherein the dynamic electrical power prices of each area are determined independently of the electrical power prices of other areas. When executed by the at least one computer system, the dynamic electrical power price distribution application transmits the dynamic electrical power prices to the residential consumers. The status information comprises at least one of when the last dynamic electrical price was received, what the last received dynamic electrical power price value was, how much electrical load can be shed by the residential consumer, a control mode of an electrical power controller, and communication network diagnostic information.

In an embodiment, a method of electrical power distribution is disclosed. The method comprises transmitting a plurality of status request messages, transmitting one status request message to at least one residential consumer of electrical power in each of a plurality of electrical service areas, the electrical service areas located in a plurality of districts and receiving a plurality of status update messages comprising status information, one status update message transmitted automatically from at least some of the residential consumers to which the status request message was transmitted. The method further comprises automatically determining a plurality of electrical power loads associated with a plurality of residential consumers of electrical power from an electrical power grid, wherein the electrical power loads are determined independently for each area and automatically determining a plurality of electrical power sources supplying electrical power to the electrical power grid associated with producers of electrical power. The method further comprises automatically modulating the electrical power loads and the electrical power sources by determining by a computer a plurality of dynamic electrical power prices based at least on the electrical power loads, the electrical power sources, and the status information, wherein the dynamic electrical power price is determined independently for each area and transmitting by a computer the dynamic electrical power prices to the residential consumers and producers, whereby the electrical power loads and the electrical power supplies are influenced by the dynamic electrical power prices. The status information comprises at least one of when the last dynamic electrical price was received, what the last received dynamic electrical power price value was, how much electrical load can be shed by the residential consumer, a control mode of an electrical power controller, and communication network diagnostic information.

In an embodiment, a method of communicating dynamic electrical power pricing information is disclosed. The method comprises determining by a computer system a plurality of electrical power prices for a plurality of residential consumers based on a time associated with the prices and based on a plurality of geographical locations associated with the residential consumers, transmitting by a computer system a plurality of pricing messages comprising electrical power prices to the residential consumers, wherein at least two of the electrical power prices for the residential consumers are different, and retransmitting pricing messages to at least some of the residential consumers, whereby a communication reliability is increased.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a dynamic electrical power pricing communication system according to an embodiment of the disclosure.

FIG. 2 illustrates an electric utility according to an embodiment of the disclosure.

FIG. 3 illustrates an exemplary computer system suitable for implementing the several embodiments of the disclosure.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents.

A dynamic electrical power pricing communication system and method are taught by the present disclosure. In an embodiment, electrical power retail prices are determined periodically by electrical utilities based on wholesale prices promulgated by independent service operators (ISOs) and or regional transmission operators (RTOs), based on current generation and distribution costs, based on current electrical load conditions, based on the location of the electrical power consumer, based on status information reported by one or more electrical power consumers, and/or based on the electrical power subscription plan and/or contract of the electrical power consumer. The electrical power retail price may be determined about every five minutes, about every ten minutes, about every hour, or some other periodic interval and transmitted to an information gateway or computer located at the residence or business location of the electrical power consumer. In some contexts herein the information gateway or computer located at the residence or business location of the electrical power consumer will be referred to as the electrical power consumer. The periodic determination and distribution of electrical power retail prices that may change over relatively short intervals of time may be referred to as dynamic electrical power pricing or dynamic pricing. The dynamic electrical power pricing is the price per unit of electrical power that will be billed to an electrical power consumer during the subject time interval. The period of determining the electrical power retail price may change based on grid loading, based on a load class of electrical power consumers, and/or based on an electrical power export class of electrical power consumers in the particular geographic area.

In an embodiment, an information gateway receives the transmitted dynamic pricing and returns status. In an embodiment, the information gateway may be coupled to an electrical power meter or smart meter that communicates electrical power consumption data to the information gateway. In another embodiment, the electrical power meter and/or smart meter may be integrated with the information gateway. The information gateway also may be coupled to an electrical power system controller within the residence and/or business to monitor and control electrical loads presented by devices including, but not limited to, air conditioning, electric heating appliances, electric fans and/or blowers, electric dryers, electric lights, computers, televisions, electric motors, and other electrical devices. In an embodiment, the information gateway or smart meter may determine an electrical power consumption bill based on both electrical power consumption over a time interval and on the dynamic pricing in effect during the same time interval. Thus, an electrical power bill may be determined by the information gateway as the sum of individual billings for each of a number of periodic intervals having possibly different dynamic pricing in effect during each of the periodic intervals. Alternatively, the information gateway may track electrical power consumption by time and dynamic pricing by time and transmit this tracking data to a different point, for example to an electric utility billing server, for determination of the electrical power bill.

The controller may adjust the electrical load placed on the grid by the residence or the business in response to the dynamic pricing information received by the information gateway. For example, the controller in a residence may adjust an air conditioning set point temperature from 74 degrees Fahrenheit upwards to 78 degrees Fahrenheit in response to a materially higher dynamic price during a time interval. Likewise, a controller in a business may adjust its electrical power load placed on the grid in response to the dynamic pricing information received by the information gateway, for example, rearranging a workflow to delay a procedure that consumes a relatively high amount of electricity based on a current dynamic price. Further, residential and business electrical power consumers that have electrical power exporting capabilities may bring electrical power generating facilities on-line and/or redeploy already on-line electrical power generating facilities to export electrical power to the grid in response to the dynamic pricing information, for example to take advantage of an above average dynamic price value.

Communicating dynamic prices periodically, for example, but not by way of limitation, every five minutes, every ten minutes, every hour, or some other periodic interval to every electrical power consumer in a service area presents a serious communication and/or economic challenge. It should be remembered that, in an embodiment, the dynamic prices may vary from area to area, for example from a first area served by a first electrical substation to a second area served by a second electrical substation, or from a third area served by a first step-down transformer to a fourth area served by a second step-down transformer, and hence the same dynamic price may not be broadcast to all electrical consumers. Thus, a large number of distinctive electrical pricing information may need to be transmitted and delivered periodically. It is contemplated that the electrical power utilities and/or organizations that manage the grid may modulate the dynamic pricing to shape the load on the electrical power grid as well as to shape the supply of electrical power exported to the electrical power grid. To achieve these objectives, it is desirable for the dynamic pricing to be timely and reliably transmitted to as many of the electrical power consumers as possible. Further, it is desirable that the costs of communicating the dynamic pricing be kept low.

The present disclosure describes the application of cloud computing to address this communication challenge. In an embodiment, a first application executing in the cloud computing environment distributes dynamic pricing information received from electric utilities to electrical power consumers and/or exporters of electrical power, where the dynamic pricing information may differ during the same dynamic pricing interval between proximate but different small geographic areas. In an embodiment, a second application executing in the cloud computing environment receives and collects status information transmitted by the electrical power consumers. In an embodiment, the electrical power utility communicates with both the first application to provide dynamic pricing information and with the second application to receive the status information collected from the electrical power consumers. A third application executing on a computer system in the electric utility may determine the dynamic pricing information. A fourth application executing on a computer system in the electric utility may analyze the status information received from the second application and provide the results of the analysis to the third application as a form of feedback. The fourth application also may receive the status information from the second application as well as loads and other operating parameters sensed at different points in the grid. In an embodiment, one or both of the third and fourth applications may execute in the cloud computing environment rather than in the electric utility.

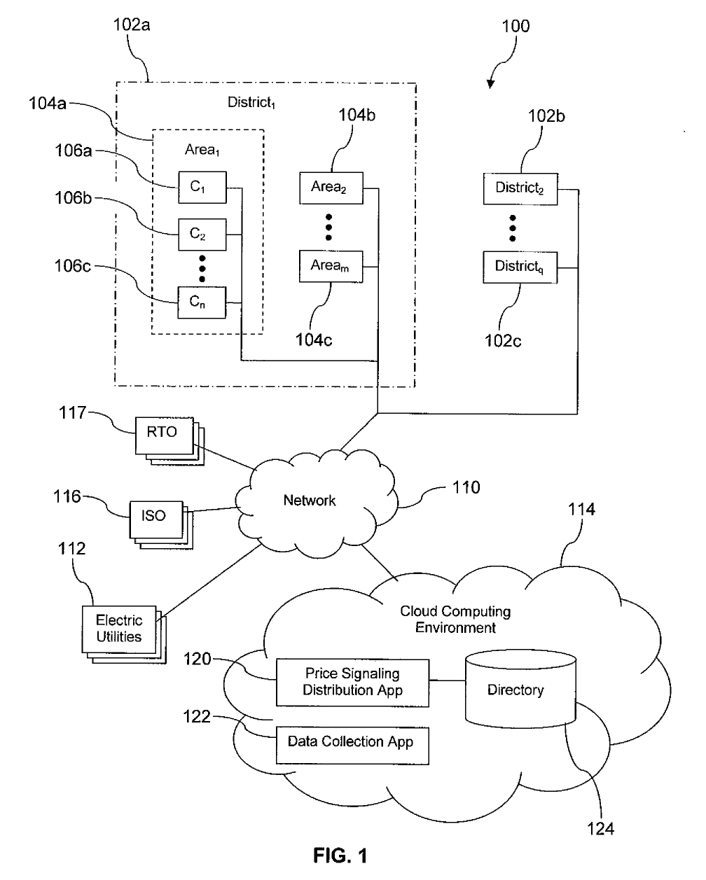

Turning now to FIG. 1, a dynamic pricing communication system 100 is now described. The system comprises a plurality of electrical power distribution districts 102 each of which is subdivided into a plurality of electrical power distribution areas 104 each of which in turn is comprised of a plurality of electrical power consumers 106. The electrical power consumers 106 may include residential consumers of electrical power and business consumers of electrical power. Residential consumers may have electrical power services of about 120 volts and/or about 220 volts and a maximum power consumption on the order of 30 kilowatts. Business consumers may have electrical power services of about 120 volts and/or 220 volts with a higher maximum power consumption, sometimes a much higher maximum power consumption. Additionally, some business consumers, such as manufacturing facilities, may have 440 volt services or special voltage services provided by the electric utility 112. The term electrical power consumer and/or consumer as used herein may mean either a residential electrical power consumer or a business electrical power consumer. When a distinction between these two different types of consumer is germane to the disclosure, this distinction will be pointed out.

FIG. 1 illustrates a first district 102a, a second district 102b, and a third district 102c, but it is understood that any number of districts is within the scope and spirit of the present disclosure. FIG. 1 illustrates the first district 102a comprising a first area 104a, a second area 104b, and a third area 104c, but it is understood that the districts 102 may comprise any number of areas 104. FIG. 1 illustrates the first area 104a comprising a first electrical power consumer 106a, a second electrical power consumer 106b, and a third electrical power consumer 106c, but it is understood that the areas 104 may comprise any number of electrical power consumers 106. Hereinafter, in the interests of brevity, the electrical power consumers 106 are referred to as consumers 106. The geographical segmentation of an electrical service area into districts and areas may be made according to a variety of criteria. In an embodiment, the geographical segmentation into districts and areas may be based, at least in part, on the electrical power distribution grid. For example, areas may be associated to electrical sub-stations that service the area. Alternatively, areas may be associated with step-down transformers that service the area, where a plurality of step-down transformers may be served by a single electrical sub-station. For example, districts may be associated to electrical power generation facilities that service the district.

While in FIG. 1, three levels of geographical granularity—district, area, and consumer premises—are illustrated, one skilled in the art will readily appreciate that other hierarchical geographical configurations are possible, all of which are within the spirit and scope of the present disclosure. In an embodiment, the electrical power distribution geography may be partitioned into four levels of geographical granularity, into five levels of geographical granularity, or into greater number of levels of geographical granularity. Alternatively, the electrical power distribution geography may be partitioned into two levels of geographical granularity. Additionally, in some cases a hybrid geographical hierarchy that includes consumers located at a third level of the geographical hierarchy as well as other consumers located at a second level of the geographical hierarchy or at a first level of the geographical hierarchy. For example, in an exemplary electrical power distribution geography, an aluminum mill consumer 106 may be located at a first level of the geographical hierarchy—a peer to an entire district 102—while a residential consumer 106 may be located at a third level of the geographical hierarchy.

In an embodiment, higher level geographical spaces, for example neighborhoods, boroughs, school districts, school attendance zones, postal zip code areas, service areas of grid nodes and/or branches, townships, counties, states, provinces, and nations, may be included in the partitioning of the grid. While the consumers 106, the areas 104, and the districts 102 are represented in FIG. 1 connected to a backbone which in turn is coupled to the network 110, it is understood that each consumer 106 may be coupled to the other consumers 106, to the price signaling distribution application 120, to the data collection application 122, and to the electric utilities 112 through the network 110. Additionally, the links illustrated in FIG. 1 are intended to represent communication links rather than power distribution links.

The system 100 further comprises a communication network 110, a plurality of electric utilities 112, a cloud computing environment 114, optionally a plurality of independent service operators (ISOs) 116, and optionally a plurality of regional transmission operators (RTOs) 117. The consumers 106, the electric utilities 112, the cloud computing environment 114, the independent service operators 116, and the regional transmission operators 117 may communicate with one another via wired and/or wireless links to the network 110. The network may comprise a public switched telephone network, a public data network, a private network, and combinations thereof. In an embodiment, the independent service operators 116 and/or the regional transmission operators 117 may not have a role in system 100, for example in electrical power grids outside of the United States. The independent service operators 116 and the regional transmission operators 117 may be formed under the direction of governmental agencies to coordinate, control, and monitor the operation of the electrical power grid. The regional transmission operators 117 may differ from independent service operators 116 by having jurisdiction over a larger geographical area than the independent service operators.

The electric utilities 112 may be businesses that own electrical power generating plants, electrical transmission lines, and/or electrical power distribution facilities. Electrical utilities 112 may comprise rural and/or municipal electrical power generating cooperatives as well as large public companies serving consumers 106 located in many cities and/or in a plurality of states. In some embodiments, some electric utilities 112 may not own any electrical plant but may be electrical power resellers.

The cloud computing environment 114 provides cloud computing services to the electric utilities 112. As known to those of skill in the art, cloud computing typically involves a dynamically scalable computing resource provided by a plurality of computer systems. Computer systems are discussed further hereinafter. Often, the dynamic scalability is supported by virtualization software that promotes providing services to clients over the network 110, for example over the Internet, from a plurality of virtual servers. For example, the virtualization software may promote supporting client requests on twenty virtual servers executing on four physical computers. In an embodiment, an electric utility 112 may establish and operate the cloud computing environment 114. Alternatively, in another embodiment, an electric utility 112 may subscribe to, lease, or hire access to cloud computing environment 114 from a cloud computing provider. Relying upon a third party cloud computing provider may have advantages of reduced capital equipment expenses and competitive on-going expenses. Additionally, a third party cloud computing provider may be able to provide on-demand computing resources when special grid operating events occur such as a transition associated with adopting new regulatory rules or when grid outages caused by severe weather occur. In an embodiment, the cloud computing environment 114 may be replaced by a plurality of servers, for example a server farm.

In an embodiment, the cloud computing environment 114 comprises a price signaling distribution application 120, a data collection application 122, and a data store containing a directory 124 that maps consumers 106 to leaf nodes of the grid, for example to service delivery points such as a neighborhood step-down transformer. The signaling distribution application 120 may be stored in a memory in the cloud computing environment 114 and executed by one or more processors in one or more computers in the cloud computing environment 114. The data collection application 122 may be stored in a memory in the cloud computing environment 114 and executed on one or more processors in one or more computers in the cloud computing environment 114.

The price signaling distribution application 120 may receive dynamic electrical power pricing input from the electric utilities 112 and periodically generate and transmit a plurality of dynamic pricing messages to the consumers 106. While shown in FIG. 1 as a single price signaling distribution application 120, in an embodiment the price signaling distribution function may be performed by a dynamic electrical power price generation application and a dynamic electrical power price distribution application. The electrical power prices may be transmitted to consumers 106 periodically. Dynamic electrical power pricing may be transmitted on one or more of a daily period, a four hourly period, an hourly period, a quarter hourly period (e.g., fifteen minute period), a ten minute period, or a five minute period. Because of the large number of consumers 106, for example because of the large number or residential electrical power consumers, the transmission of dynamic pricing information messages to all consumers 106 may take as much as a tenth of the update period, for example as much as thirty seconds when a five minute update period is employed or as much as sixty seconds when a ten minute update period is employed. In an embodiment, a consumer 106 may be eligible to selectively receive electrical power service from two or more different electric power utilities 112. In this circumstance, the price signaling distribution application 120 may transmit dynamic pricing messages associated with each of the eligible alternative electric utilities 112 to the subject consumer 106. This may promote the subject consumer 106 selecting from the alternative electrical power services, for example based on a lowest price, thereby adapting to the price signaling and contributing to the desired load shaping.

In an embodiment, the dynamic pricing messages may be sent more than once to the consumers 106 to promote increased reliability in the context of non-guaranteed reception. For example, two messages containing the same dynamic pricing information may be sent out seconds apart to the same consumers 106 and/or cluster of consumers 106 associated with the same grid terminal node. Alternatively, two messages containing the same dynamic pricing information may be sent out to the same consumers 106 and/or cluster of consumers 106 associated with the same grid terminal node approximately half-way through the periodic dynamic pricing update interval, for example 150 seconds after the first transmission when a 5 minute dynamic pricing update interval or period is used or about 300 seconds after the first transmission when a 10 minute periodic dynamic pricing update interval is used. Alternatively, other messaging mechanisms may be employed to increase reliability, for example acknowledge request (ARQ) mechanisms, hybrid acknowledgement request (HARQ) mechanisms, a reliable transport protocol such as the transport control protocol (TCP), and other communication mechanisms known to those skilled in the art. In an embodiment, a learning algorithm may be employed by the price signaling distribution application 120 to adaptively select communication reliability techniques based on communications history in the district 102 and/or area 104.

In an embodiment, different levels of communication reliability may be applied to different classes of consumers 106. For example, a higher level of communication reliability, which may entail more communications overhead, may be employed for transmitting dynamic pricing information to a large aluminum mill consuming large amounts of electrical power, because it may be expected that providing dynamic pricing information timely to the aluminum mill would contribute much to the desired load shaping. It should be observed that the number of comparably high load electrical consumers is relatively smaller in number than the number of moderate to low load electrical consumers. Likewise, a higher level of communication reliability may be employed for transmitting dynamic pricing information to a business having a large capacity for generating and exporting electrical power to the grid, because it may be expected that providing dynamic pricing information timely to the exporting consumer would contribute much to the desired supply shaping. For example, communications employing acknowledged transmissions and automatic repeat requests in the absence of timely acknowledgement may be employed for such high load and high exporting consumers 106. Additionally, dynamic pricing information may be generated more frequently by the electric utility and transmitted by the price signaling distribution application 120 to the high load/export consumers 106 more frequently than the corresponding dynamic pricing information is transmitted to the moderate and low load/export consumers 106.

In an embodiment, a selected one moderate or low load/exporting consumer 106 among a geographical cluster of many moderate or low load/exporting consumers 106 may be configured to use high reliability communication for receiving dynamic pricing information, for example employing acknowledged transmissions and automatic repeat requests in the absence of acknowledgement. The electric utility 112 may use the selected consumer 106 to detect a general communication fault that affects most or all consumers 106 in the subject area 104. Alternatively, the price signaling distribution application 120 may occasionally send a command to a consumer 106 to employ high reliability communication for receiving the next dynamic pricing information message as a representative of the communication status in the area 104. In an embodiment, the price signaling distribution application 120 may request status and/or feedback from the consumer 106 at any time. In an embodiment, the price signaling distribution application 120 may request the consumer 106 to return the last dynamic pricing information received by the consumer 106 in a status message to the data collection application 122.

In the event that a consumer 106 misses three consecutive dynamic price information messages, the consumer 106, or the information gateway associated with the consumer 106, may send a critical event message to an alarm system operated by the electric utility 112. The critical event message may be transmitted using high reliability communication techniques, for example acknowledgment request with automatic repeat in the absence of timely acknowledgment.

The dynamic pricing information message may comprise an indication of when the next dynamic pricing information message is to be sent and/or the length of the next dynamic pricing interval. The length of dynamic pricing interval may be different for different levels of consumers. Additionally, the length of dynamic pricing interval may be different at different times of day, at different times of year, and/or under different grid conditions. For example, consumers 106a associated with the first area 104a may receive dynamic pricing information messages periodically every five minutes from 2 PM until 8 PM and may receive dynamic pricing information messages periodically every hour from 8 PM until 8 AM the next day. The dynamic pricing itself may likewise be determined at different periodic rates at different times for the same area. Determination of dynamic pricing and transmitting of dynamic pricing information messages may occur at different periodic rates during the same time for different areas. For example, dynamic pricing may be determined and transmitted in dynamic pricing information messages at a five minute periodic rate from 2 PM until 8 PM to the first area 106a while dynamic pricing may be determined and transmitted in dynamic pricing information messages at a fifteen minute periodic rate from 2 PM until 8 PM to the second area 106b. The ability to dynamically adjust the periodic rate of determining and transmitting electrical pricing information over time in the same area and to adjust the periodic rate of determining and transmitting electrical pricing at the same time between different areas provides the capability of fine grained, precise modulation of electrical loads on the power grid.

In an embodiment, the electric utilities 112 may send the dynamic pricing input to the price signaling application 120 in the form of a pricing schema, for example in an extensible markup language (XML) document. The electric utilities 112 may receive electrical power wholesale pricing and/or pricing guidance from independent service operators 116 and/or regional transmission operators 117 and determine the dynamic pricing information based at least in part on this electrical power wholesale pricing information. In some electrical power distribution zones, the independent service operators 116 and or regional transmission operators 117 may promulgate the electrical power wholesale pricing information on 5 minute periodic intervals, 10 minute periodic intervals, or some other periodic interval.

Because the capacity of the grid to deliver electrical power may materially differ at different end nodes and/or leaf nodes of the grid, and because loads placed on the grid by the consumers 106 may materially differ at the different end nodes and/or leaf nodes of the grid, the dynamic electrical power pricing determined by the electric utilities 112 for proximate and/or neighboring nodes may likewise materially differ. The determination of electrical pricing for the first area 106a may be said to be independent of the determination of electrical pricing for the other areas 106. For example, two adjacent residential subdivisions may be located within a radius of a half mile of each other, but because a sub-station supplying a first residential subdivision is in need of maintenance and is desirably being operated at a maximum of 70% of rated capacity, the first residential subdivision may receive electrical power priced materially higher than the electrical power supplied to the adjacent subdivision that may be supplied electrical power from a different fully functional sub-station. Many electric utilities 112 already monitor grid operating parameters at a number of points within the grid, and this information may be employed by the electric utilities 112 to determine the dynamic electrical power pricing information.

At present, in many electrical power distribution zones, electrical power customarily may be provided at a fixed rate to all residential consumers 106 within a large geographical region and for an extended period of time. For example, all residential customers in a large metropolitan area, e.g., the Chicago metropolitan area, may receive their electrical power at a fixed rate during a 6 month or longer period of time. In the context of dynamic electrical power pricing, the electric utilities can shape the load and the electrical power exporting of the consumers 106 by modulating the pricing both with reference to time and with reference to fine grained geographical location, whereby the strengths and weaknesses of the grid can best be accommodated to achieve energy efficiency, grid reliability, and desired behavior of consumers 106. For example, but not by way of limitation, an overbuilt suburb may be supplied electrical power priced at a premium relative to another suburb that is managing growth more conservatively, promoting gradual growth that accords better with the limited agility of the grid in adapting to changed demographic distributions. Additionally, the electric utilities 112 may use dynamic pricing to modulate electrical power consumption by consumers 106 during grid disruptions, for example during grid failures or during scheduled maintenance involving taking some electrical power equipment off-line.

In an embodiment, a business consumer 106 may deploy a sophisticated electrical power controller on the business premises to manage electrical power costs. The electrical power controller may be communicatively coupled to the information gateway and receive dynamic pricing information from the information gateway. The electrical power controller may modulate air handling equipment—air conditioning and/or heating—to reduce electrical power expenses based on work schedules as well as the dynamic electrical power pricing. The electrical power controller may command the deferral of a manufacturing procedure that consumes relatively high quantities of electrical power from a time of high dynamic pricing to a time of lower dynamic pricing, for example to a night shift.

The electrical power controller may maintain histories of dynamic electrical power. The electrical power controller may receive reports on the status of the electrical power grid transmitted by the electric utilities via the information gateway to the electrical power controller. The electrical power controller may forecast dynamic pricing over the next day or over the next week and schedule manufacturing procedures and work shifts based on the forecast so as to reduce electrical power costs. Alternatively, the electrical power controller may receive similar forecasts of dynamic pricing from the electric utilities 112.

The electrical power controller may schedule manufacturing procedures and work shifts to redeploy co-generation equipment and/or electrical power generation equipment for exporting electrical power to the grid during periods of high dynamic pricing. The electrical power controller may schedule low efficiency generation equipment, for example diesel powered generators and/or natural gas powered generators, to generate and export electricity to the grid based on the forecast and based on other data input by an operator using an interface of the electrical power controller, for example an inventory price of diesel fuel and a price of natural gas. The electrical power controller may identify preferred maintenance windows for maintaining and/or refurbishing electrical equipment based on the forecast of future dynamic pricing.

The price signaling distribution application 120 may determine the number of messages and the addresses and/or universal reference locators (URLs) to which to transmit the dynamic pricing messages from the directory 124 or other map of the consumers 106 to areas 104 and to districts 102. The price signaling distribution application 120 may further determine the dynamic pricing information to send in the dynamic pricing message based on the pricing schema and based on the directory 124 or other map of the consumers 106. For example, the first consumer 106a, the second consumer 106b, and the third consumer 106c each may be provided electrical power by the electric utility 112 at the same dynamic price because they are associated with substantially the same end node or leaf of the grid and hence their loads may be aggregated by the electric utility 112. Thus, in an embodiment, a dynamic pricing message may be multicast by the price signaling distribution application 120 to the consumers 106a, 106b, and 106c via the network 110. In an embodiment, the price signaling distribution application 120 may employ relayed multicast communication techniques and/or publish-subscribe communication techniques to send the dynamic pricing messages to the consumers 106. In an embodiment, the dynamic pricing message may be sent to a single distribution gateway in each area, and the distribution gateway may then relay the dynamic pricing message to each of the consumers within its area. It is understood that the current electricity pricing conveyed in the dynamic pricing message sent to a first distribution gateway in the first area 104a may be different from the current electricity pricing conveyed in the dynamic pricing message sent to a second distribution gateway in the second area 104b.

The data collection application 122 receives periodic status updates and/or status messages from the consumers 106 via the network 110. The status messages may be said to be automatically transmitted and/or electronically transmitted by the consumers 106. The period of the status updates and/or messages transmitted by the consumers 106 may not coincide with or have the same period as the pricing signal messages sent to the consumers 106 by the price signaling distribution application 120. For example, the status updates and/or messages may be transmitted less frequently from the consumers 106 to the data collection application 122 than the dynamic pricing information is transmitted from the dynamic pricing application 120 to the consumers 106. For example, the status updates and/or messages may be transmitted by the consumers 106 to the data collection application 122 about daily, about every four hours, about every hour, about every 15 minutes, about every 10 minutes, about every 5 minutes, or some other periodic interval.

The status information contained in the status updates and/or status messages may comprise an on-line/off-line status, an electrical power meter reading, an amount of load curtailment provided by a controller at the consumer premises, and other status information. The status information may indicate the time that the last pricing signal message was received and/or the content of the last dynamic pricing information received by the consumer 106. The status information may indicate a load curtailment being applied by the consumer 106, for example a load curtailment accomplished during the preceding status reporting and/or electrical power pricing interval. The status information may indicate a control mode of an electrical power controller. For example, an electrical power controller in a residence may be set to a manual mode in which it may not adapt power consumption based on pricing signals. The electrical power controller in the residence or business maybe set to a maximum load shedding operating mode or to a minimum load shedding operating mode or some other load shedding operating mode.

The status information may indicate communication network diagnostic information. For example, the communication network diagnostic information may comprise values of various error counters such as counts of packet error loss and other error counters. The communication network diagnostic information may comprise a list of one or more specific communication errors, identifying the communication errors by name or by a code. The communication network diagnostic information may comprise data packet latency times—the amount of time it takes a data packet to transit the network. The status information may further comprise an electrical power export capacity status and an availability for electrical power export status. The status information may comprise an indication of a preference by the consumer 106 that their electrical power be generated by a renewable energy source such as hydropower, geothermal power, and/or wind power.

The status information may be forwarded by the data collection application 122 to the electric utility 112. In an embodiment, the data collection application 122 may pre-process the status information before forwarding to the electric utility 112, for example aggregating some of the data to provide various rolled-up statistics. The status information may be useful for determining whether the consumer 106 is able to respond to the pricing signal, for example whether the consumer 106 is able to modulate the electrical power load they put on the grid. For example, the status information may comprise an indicator of how much load the consumer 106 is able to shed if need be. The transmission of status information from the consumers 106 back to the data collection application 122 may provide more visibility and/or finer grain visibility by the electric utilities 112 into the status of the grid, into faults on the grid, and/or into failures on the grid. The status information reported by the consumers 106 back to the data collection application 122 and thence back to the electric utilities 112 may promote improved energy management processes.

In an embodiment, the consumers 106 in first area 104a may send their status information to a first gateway, the first gateway may aggregate the information of the consumers 106 into a single status message, and the first gateway may then transmit the aggregated status message to the data collection application 122. The consumers in other areas 104, likewise, would send their status information to a gateway associated with their area, that gateway would aggregate the information into a single status message, and that gateway may then transmit the aggregated status message to the data collection application 122. Alternatively, in an embodiment, a reduced number of consumers 106 in each area 104, for example less than fifty percent of the residential consumers in the first area 104a, less than twenty percent of the residential consumers in the first area 104a, less than ten percent of the residential consumers in the first area 104a, or some other fraction of the residential consumers in the first area 104a may transmit status messages to the data collection application 122, whereby the status message handling load on the data collection application 122 may be reduced.

The data collection application 122 may support other uplink communications from the consumers 106, for example receiving and processing registration messages from consumers 106 entering into the dynamic pricing system and security tokens from consumers 106 to authenticate themselves to establish a communication session.

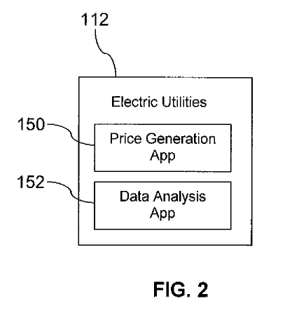

Turning now to FIG. 2, an exemplary electric utility 112 is described in more detail. The electric utility 112 may comprise a price generation application 150 and a data analysis application 152. It is understood that the electric utility 112 may further comprise electric power generation equipment (not shown) and electric power distribution equipment (not shown). The price generation application 150 may be stored in a memory and executed by one or more processor of a computer system in the electric utility 112. The data analysis application 152 may be stored in a memory and be executed by one or more processors of a computer system in the electric utility 112. Alternatively, the price generation application 150 and the data analysis application 152 may execute in the cloud computing environment 114. The price generation application 150 may receive wholesale electrical power pricing information from the independent service operators 116 and/or the regional transmission organizations 117. The data analysis application 152 may receive status information from the data collection application 122 and analyze this data to determine a status and/or condition of the grid. The data analysis application 152 provides the analysis results to the price generation application 150, and the price generation application 150 determines a dynamic price for the variety of consumers 106 distributed over the variety of areas and districts based on the analysis results and based on the wholesale electrical power pricing information. The communication between the price generation application 150 and the independent service operators 116, the regional transmission organizations 117, the price signaling distribution application 120, and the data collection application 122 may employ high reliability communication techniques as described above. In an embodiment, the electric utility 112 may execute a redundant price generation application 150 and a redundant data analysis application 152 on one or more computer systems located in a different geographical region from the computer systems on which the primary price generation application 150 and the primary data analysis application execute on. This would provide both application diversity and geographical diversity that would promote high reliability.

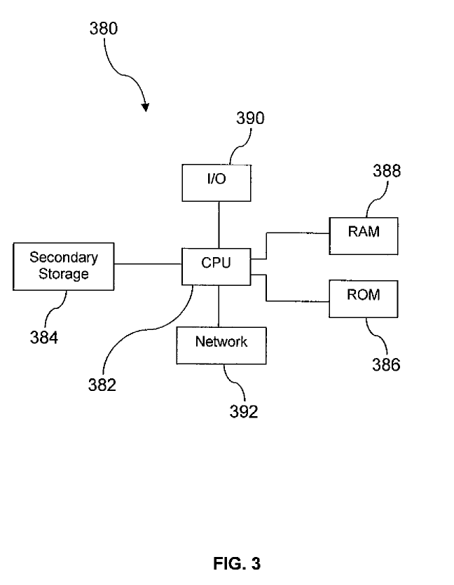

FIG. 3 illustrates a computer system 380 suitable for implementing one or more embodiments disclosed herein. For example, the computer system 380 may be used to implement one or more physical computers in the cloud computing environment 114, in the electric utilities 112, in the independent service operators 116. Additionally, the electrical power controllers discussed above may be implemented as the computer system 380. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, RAM 388, and ROM 386 may be referred to in some contexts as non-transitory storage or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 392 may enable the processor 382 to communicate with an Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embodied in the carrier wave generated by the network connectivity devices 392 may propagate in or on the surface of electrical conductors, in coaxial cables, in waveguides, in an optical conduit, for example an optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data which may be accessed from the hard drive, floppy disk, optical disk, ROM 386, and RAM 388 may be referred to in some contexts as non-transitory instructions or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide 20 virtual servers on 4 physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein implementing the functionality disclosed above. The computer program product may comprise data, data structures, files, executable instructions, and other information. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data in part by directly accessing the computer program product, for example by reading from a CD-ROM disk inserted into a disk drive peripheral of the computer system 380. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A dynamic electrical power pricing communication system, comprising:
at least one computer system;
at least one memory;
a data analysis application stored in the at least one memory that, when executed by the at least one computer system, receives status information from a plurality of residential consumers and analyzes the status information, wherein the residential consumers are located in a plurality of districts, each district comprising a plurality of areas, each area comprising a plurality of residential consumers, and wherein at least one residential consumer in each area periodically automatically transmits status information to the data analysis application;
a dynamic electrical power price generation application stored in the at least one memory that, when executed by the at least one computer system, receives wholesale electrical power pricing information and determines a plurality of dynamic electrical power prices for the residential consumers based on the analysis of the status information, based on the area of the residential consumers, wherein the dynamic electrical power prices of each area are determined independently of the electrical power prices of other areas; and
a dynamic electrical power price distribution application stored in the at least one memory that, when executed by the at least one computer system, transmits the dynamic electrical power prices to the residential consumers,
wherein the status information comprises at least one of when the last dynamic electrical price was received, what the last received dynamic electrical power price value was, how much electrical load can be shed by the residential consumer, a control mode of an electrical power controller, and communication network diagnostic information.

2. The system of claim 1, wherein less than half of the residential consumers per area periodically automatically transmit status information.

3. The system of claim 1, wherein the electrical power prices are transmitted periodically to residential consumers on one or more of a daily period, a four hourly period, an hourly period, a quarter hourly period, or a five minute period.

4. The system of claim 1, wherein the status information received from the residential consumers comprises an indication of an amount of electrical power consumption curtailment.

5. The system of claim 1, wherein
the data analysis application further receives status information transmitted electronically from a plurality of commercial consumers and analyzes the status information from the commercial consumers,
the dynamic electrical power price generation application further determines a plurality of dynamic electrical power prices for the commercial consumers based on the analysis of the status information and based on the area of the commercial consumers, wherein the dynamic electrical power prices for the commercial consumers of each area are determined independently of the electrical power prices of commercial consumers of other areas, and
the dynamic electrical power price distribution application transmits the dynamic electrical power prices to the commercial consumers.

6. A method of electrical power distribution, comprising:
transmitting a plurality of status request messages, transmitting one status request message to at least one residential consumer of electrical power in each of a plurality of areas, the areas located in a plurality of districts;
receiving a plurality of status update messages comprising status information, one status update message transmitted automatically from at least some of the residential consumers to which the status request message was transmitted;
automatically determining a plurality of electrical power loads associated with a plurality of residential consumers of electrical power from an electrical power grid, wherein the electrical power loads are determined independently for each area;
automatically determining a plurality of electrical power sources supplying electrical power to the electrical power grid associated with producers of electrical power; and
automatically modulating the electrical power loads and the electrical power sources by
determining by a computer a plurality of dynamic electrical power prices based at least on the electrical power loads, the electrical power sources, and the status information, wherein the dynamic electrical power price is determined independently for each area and
transmitting by a computer the dynamic electrical power prices to the residential consumers and producers,
whereby the electrical power loads and the electrical power supplies are influenced by the dynamic electrical power prices,
wherein the status information comprises at least one of when the last dynamic electrical price was received, what the last received dynamic electrical power price value was, how much electrical load can be shed by the residential consumer, a control mode of an electrical power controller, and communication network diagnostic information.

7. The method of claim 6, wherein the dynamic electrical power prices are determined periodically and transmitted periodically to residential consumers and producers.

8. The method of claim 7, wherein the dynamic electrical power prices are transmitted more frequently to a first group of residential consumers located in a first area and less frequently to a second group of residential consumers located in a second area, wherein the first group of residential consumers consume more electrical power than the second group of residential consumers.

9. The method of claim 8, wherein the dynamic electrical power prices are transmitted using high reliability communication techniques to the first group of residential consumers.

10. The method of claim 6, wherein the dynamic electrical power prices are transmitted twice to less than half of the residential consumers in each area to increase the probability of receipt.

11. The method of claim 6, wherein determining the electrical power loads is based on receiving electrical power consumption messages from a plurality of residential consumers in each area and summing a consumed electrical power metric contained in each electrical power consumption message.

12. The method of claim 6, wherein the communication diagnostic information comprises at least one of a value of an error counter, an identification of a communication error, and a latency metric.

13. A method of communicating dynamic electrical power pricing information, comprising:
determining by a computer system a plurality of electrical power prices for a plurality of residential consumers based on a time associated with the prices and based on a plurality of geographical locations associated with the residential consumers;
transmitting by a computer system a plurality of pricing messages comprising electrical power prices to the residential consumers, wherein at least two of the electrical power prices for the residential consumers are different; and
retransmitting pricing messages to at least some of the residential consumers, whereby a communication reliability is increased.

14. The method of claim 13, wherein the pricing messages further comprise a time of a next transmission of electrical power price, and wherein at least two of the times of the next transmission are different.

15. The method of claim 13, wherein the pricing messages further comprise a time duration over which the electrical power price applies.

16. The method of claim 13, wherein the computer system is a cloud computing system.

17. The method of claim 13, wherein the electrical power prices are determined by the computer system over a plurality of districts, each district comprising a plurality of areas, wherein the electrical power price is determined for residential consumers in each area independently of the electrical price determined for residential consumers in a different area in the same district, further comprising receiving a periodic status message from at least one residential consumer in each area of each district.

18. The method of claim 13, further comprising receiving a status message transmitted electronically from at least one residential consumer in each geographical location, wherein the status message comprises information about at least one of when the last dynamic electrical price was received, what the last received dynamic electrical power price value was, how much electrical load can be shed by the residential consumer, a control mode of an electrical power controller, and communication network diagnostic information, wherein the electrical power prices are determined based further on the status messages.

19. The method of claim 13, wherein electrical power prices are determined for a first group of residential consumers located in a first area at a first periodic frequency and determined for a second group of residential consumers located in a second area at a second periodic frequency, wherein the pricing messages for the first group of residential consumers are transmitted to the first group of residential consumers at the first periodic frequency and the pricing messages for the second group of residential consumers are transmitted to the second group of residential consumers at the second periodic frequency, and wherein the first periodic frequency is greater than the second periodic frequency.

20. The method of claim 13, wherein the electrical power price is determined for a first group of residential consumers in a first area at a first periodic frequency and the pricing messages are transmitted to the first group of residential consumers at the first periodic frequency during a first time interval and wherein the electrical power price is determined for the first group of residential consumers at a second periodic frequency and the pricing messages are transmitted to the first group of residential consumers at the second periodic frequency during a second time interval.
